(19) United States
(12) Patent Application Publication
(10) Pub. No.: US 2013/0195250 A1
(43) Pub. Date: Aug. 1, 2013

(54) Touch Screen Control and Method for Controlling a Radiographic Device

(71) Applicant: X-Cei X-Ray Corporation, Crystal Lake, IL (US)

(72) Inventor: Richard Quaas, Sharon, WI (US)

(73) Assignee: X-CEL X-RAY CORPORATION, Crystal Lake, IL (US)

(21) Appl. No.: 13/746,198

(22) Filed: Jan. 21, 2013

Related U.S. Application Data
(60) Provisional application No. 61/591,124, filed on Jan. 26, 2012.

(51) Int. Cl. H05G 1/38; H05G 1/30

(52) U.S. Cl. CPC H05G 1/38; H05G 1/30
USPC 378/96; 378/91

(57) ABSTRACT

Controls and methods of operating a radiographic device facilitate intuitive control of the device. A touch screen may display selectable items and a processor may have a memory for storing one or more routines for performing functions associated with the selectable items. Some of the selectable items may provide projection shortcuts, in which the memory has stored a predetermined set of voltage and exposure time values for a given projection angle and/or patient body type that are accessed and executed by the processor. Other selectable items may be provided that permit discrete, incremental changes in radiographic device settings.

### CROSS-REFERENCE TO RELATED APPLICATION

This application claims the benefit of U.S. Provisional Application No. 61/591,124, filed on Jan. 26, 2012.

### BACKGROUND

1. Technical Field

This disclosure generally relates to radiographic imaging systems and methods, and more particularly to methods and apparatus for controlling operation of radiographic devices.

2. Description of the Related Art

The benefits of radiographic devices and procedures to detect and diagnose medical conditions are well documented in the art. A radiographic device typically includes an x-ray tube that is positioned near a patient and a media for capturing an x-ray image. The radiographic device may include various controls that affect the characteristics of the radiation generated by the x-ray tube. Primary among these are a voltage control (generally measured in killivolts kV) that affects how far the radiation penetrates the target, a current control (generally measured in milliamps mA) that affects the number of photons produced by the tube that are ultimately directed toward the target area, and an exposure time control (generally measured in seconds) that affects how long the radiation is directed to the target area.

The controls provided for conventional radiographic devices are overly difficult to understand and use. Radiographic devices for generating podiatric images, for example, generally provide a separate knob for controlling each x-ray characteristic. Accordingly, the device may have a voltage control knob, a current control knob, and an exposure time control knob. Each of these control knobs allows analog input of the associated x-ray characteristic, and therefore may not permit precise settings, adjustments, or repeatability. More recently, some podiatric radiographic devices have employed membrane key pads with LED display screens. While these more recent machines may permit more precise control of x-ray characteristics, the controls may be difficult to navigate and still require the operator to have a significant level of background knowledge to select suitable settings for the desired radiographic image.

### SUMMARY OF THE DISCLOSURE

According to certain aspects of this disclosure, a radiographic device may include a base, a support arm coupled to the base, and a radiographic source coupled to the support arm and operable to generate a radiographic dose having a voltage and an exposure time. A touch screen may have a display operable to show a control option screen, the control option screen including a plurality of selectable items, and a location detector for detecting a location of an object interacting with the display and generating a location signal. A processor may be operably coupled to the radiographic source and the touch screen and includes a memory. The processor may be programmed to store a plurality of executable functions, wherein each executable function is associated with a selectable item, identify one of the selectable items as an operative selectable item corresponding to the location signal, and execute the function associated with the operative selectable item by adjusting at least one of the voltage and exposure time of the radiographic source.

According to other aspects of this disclosure, a method is provided of controlling a radiographic device having a base, a support arm coupled to the base, and a radiographic source coupled to the support arm and operable to generate a radiographic dose having a voltage and an exposure time. The method includes showing a plurality of selectable items on a display, detecting a location of an object interacting with the display and generating a location signal, identifying one of the selectable items as an operative selectable item corresponding to the location signal, and executing a function associated with the operative selectable item by adjusting at least one of the voltage and exposure time of the radiographic source.

According to further aspects of this disclosure, a controller is provided for a radiographic device having a base, a support arm coupled to the base, and a radiographic source coupled to the support arm and operable to generate a radiographic dose having a voltage and an exposure time. The controller includes a display operable to show a control option screen, the control option screen including a voltage control area including a voltage increase selectable item, a voltage decrease selectable item, and a voltage display box configured to display a voltage setting value, an exposure time control area including an exposure time increase selectable item, an exposure time decrease selectable item, and an exposure time display box configured to display an exposure time setting value, and a first projection shortcut selectable item. The display further includes a location detector for detecting a location of an object interacting with the display and determining a location signal, and a processor operably coupled to the touch screen and programmed to determine a voltage increase signal when the location signal is associated with the voltage increase selectable item, determine a voltage decrease signal when the location signal is associated with the voltage decrease selectable item, determine an exposure time increase signal when the location signal is associated with the exposure time increase selectable item, determine an exposure time decrease signal when the location signal is associated with the exposure time decrease selectable item, and determine a first set of predetermined voltage and exposure time signals when the location signal is associated with the first projection shortcut selectable item.

### BRIEF DESCRIPTION OF THE DRAWINGS

For a more complete understanding of the disclosed methods and apparatuses, reference should be made to the embodiment illustrated in greater detail on the accompanying drawings, wherein:

FIG. 1 is a schematic illustration of a radiographic device according to the present disclosure.

FIG. 2 is a block diagram of the radiographic device of FIG. 1.

FIG. 3 is an illustration of an exemplary welcome screen shown on a display of the radiographic device of FIG. 1.

FIG. 4 is an illustration of an exemplary control option screen shown on a display of the radiographic device of FIG. 1.

FIG. 5 is an illustration of an exemplary confirmation screen shown on a display of the radiographic device of FIG. 1.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

This disclosure relates to control apparatus and methods for a radiographic device. The radiographic device is capable of delivering a radiographic dose that can be characterized by certain parameters, such as voltage and exposure time. In certain embodiments, the apparatus and methods may use a touch screen to interface with the user. A display may provide a control option screen having a plurality of selectable items. The selectable items may be associated with processor functions that adjust the parameters of the radiographic dose. Certain selectable items provide incremental adjustments by increasing or decreasing a parameter. Other selectable items may be associated with specific x-ray projections, and therefore may be associated with a set of predetermined parameters. The touch screen provides a clear, intuitive layout that permits a user to quickly and easily adjust the settings of the radiographic device as desired. Additionally, user selected settings may be stored to memory, thereby allowing radiographic settings to be quickly and easily repeated.

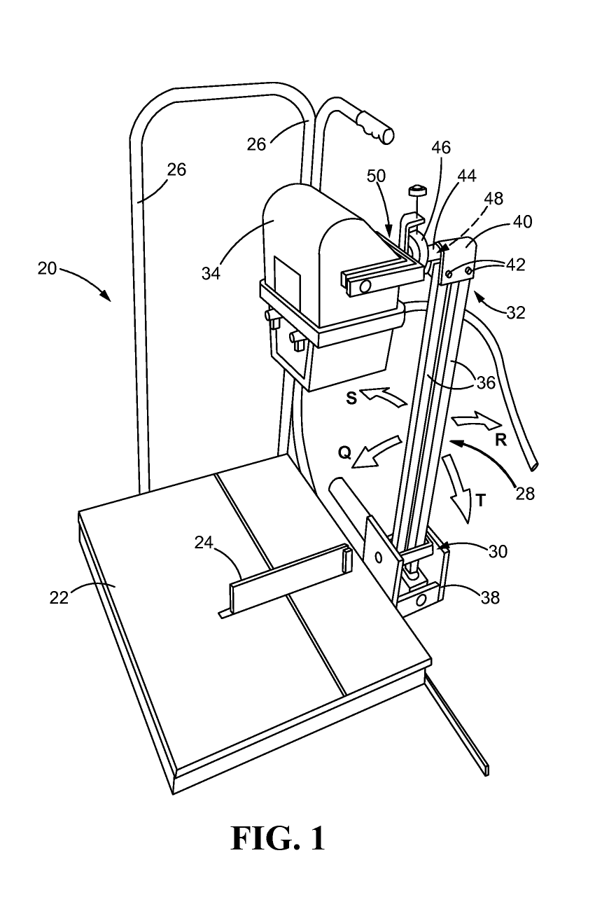

Referring now to the drawings, and with specific reference to FIG. 1, the radiographic device constructed in accordance with the teachings of the disclosure is generally referred to by reference numeral 20. The radiographic device 20 is described and illustrated herein for use in podiatry treatment, but the teachings provided herein may be applied to radiographic devices used in other fields.

The radiographic device 20 includes a foot platform 22 and a removable foot separation plate 24 extending perpendicular to the platform 22. An image capturing device, such as a film cartridge or a digital receiver, may be inserted either in the foot separation plate 24 or a tray positioned below the platform 22, depending upon the desired x-ray view. Hand rail legs 26 are mounted to the platform 22 and provide a patient support hand rail.

As shown in FIG. 1, a head mounting assembly 28 has a first end 30 pivotably coupled to the platform 22 and a second end 32 connected to a radiographic source 34. As used herein, the radiographic source is meant to include a power source and an associated collimator which is attached to and depends from the power source. The power source is capable of emitting electromagnetic radiation sufficient to generate x-ray images. The mounting assembly 28 includes a pair of vertical mounting members 36 having lower ends disposed in a mounting apparatus 38. The mounting apparatus 38 may include spring loaded mounting means for holding the vertical mounting members 36 in a desired position, such as the mounting means disclosed in U.S. Pat. No. 4,587,668, assigned to the current assignee and incorporated herein by reference. Alternatively, other means for holding the vertical mounting members 36 in place may also be used. The upper ends of the vertical mounting members 36 are coupled to a U-shaped mounting plate 40 using bolts 42. A horizontal mounting member 44 has a first end attached to the U-shaped mounting plate 40 and a free second end carrying a collar 46. The horizontal mounting member 44 is hollow to define an internal socket 48. A yoke 50 is provided for coupling the radiographic source 34 to the mounting assembly 28 and allowing angular adjustment not only about the Y axis, but also about an axis that is parallel to the lateral direction, referred to herein as the X axis.

The radiographic device 20 described herein allows the radiographic source to be positioned for multiple projections without requiring significant repositioning of the patient's feet. For example, the vertical mounting members 36 may be rotated laterally in directions S or T as shown in FIG. 1 and the radiographic source 34 may be rotated about the Y axis defined by the horizontal mounting member 44 and to obtain lateral or medial oblique projections. For these projections, the vertical mounting members 36 form substantially a right angle to the longitudinal direction. In addition, the vertical mounting members 36 may be rotated longitudinally in directions Q and R and the yoke 50 may be adjusted to an appropriate angle about the X axis to obtain additional projections such as the AP projection. The yoke 50 allows the radiographic source 34 to be tilted about the X axis so that the radiographic source 34 is directed to substantially the same target area.

The radiographic source 34 may be adjustable to generate different radiographic doses based on the type of projection or patient. Typically, a radiographic dose is measured by current (in milliamps), voltage (in kV), and exposure time (in seconds). In the exemplary embodiment, the radiographic source 34 has a set current value and adjustable voltage and exposure time values. The voltage and exposure time values needed to capture clear x-ray images may differ depending on the projection angle and patient type. Common projections for podiatric applications, for example, include dorsal/plantar (DP), lateral, lateral oblique, medial oblique, raised hallux, and axial calcaneal. Each of these projections may require the x-rays to travel through a different portion of the patient's body, and therefore may require a different voltage or exposure time to clearly capture the desired image. Still further, the body size of the patient may dictate a different voltage or exposure time, with larger patients generally requiring additional voltage and/or exposure time and smaller patients requiring less voltage and/or exposure time.

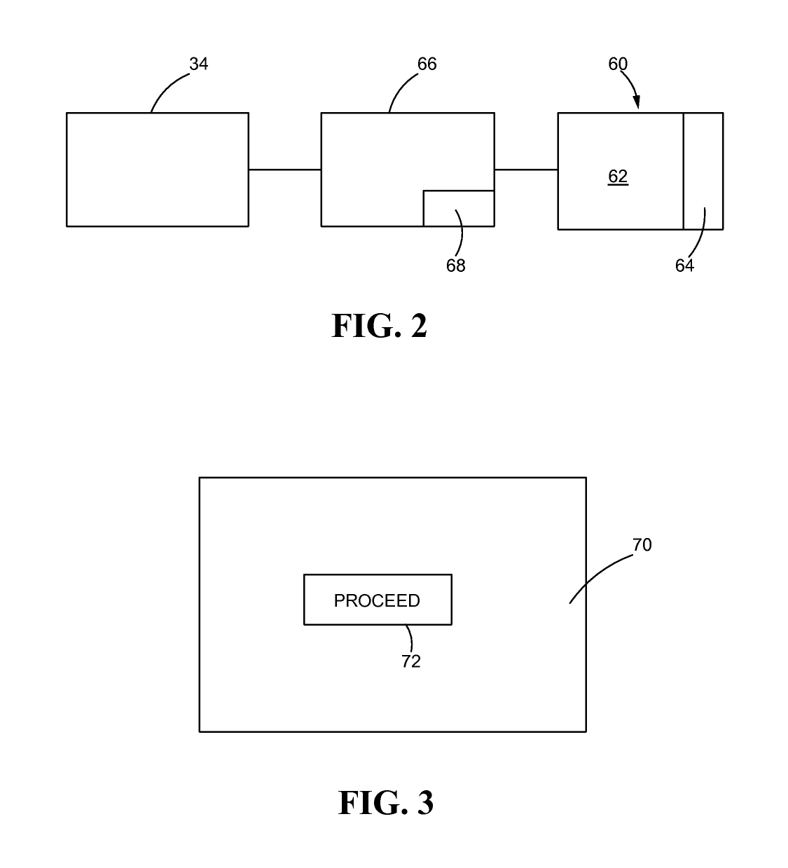

The radiographic device 20 may further include a touch screen 60 for interfacing with a user. As best shown in FIG. 2, the touch screen 60 includes a display 62 and a location detector 64. The display 62 is operative to show graphical images, such as selectable items. The location detector 64 is configured to detect a location of an interaction with the display 62 by the user. The interaction may be by a finger, stylus, or other object that is placed in contact with or in proximity to the display at a static location. Additionally or alternatively, the interaction may be a dynamic movement of the finger, stylus, or other object, such as a swiping, pinching, expanding, or other motion. The display 62 may be configured to generate a signal indicating the location at which the object interacts with the screen. An exemplary touch screen 60 having a display 62 and location detector 64 is the touch screen Model No. ezLCD-004 manufactured by Earth Computer Technologies, Inc.

A processor 66 is operatively coupled to both the radiographic source 34 and the touch screen 60. The processor 66 includes a memory 68 that may store routines for executing functions associated with the selectable items. For example, based on the stored routines, the processor 66 may be programmed to generate images on the display 62, such as the screens illustrated in FIGS. 3-5. A welcome screen 70 is shown in FIG. 3, and includes a selectable item in the form of a proceed button 72.

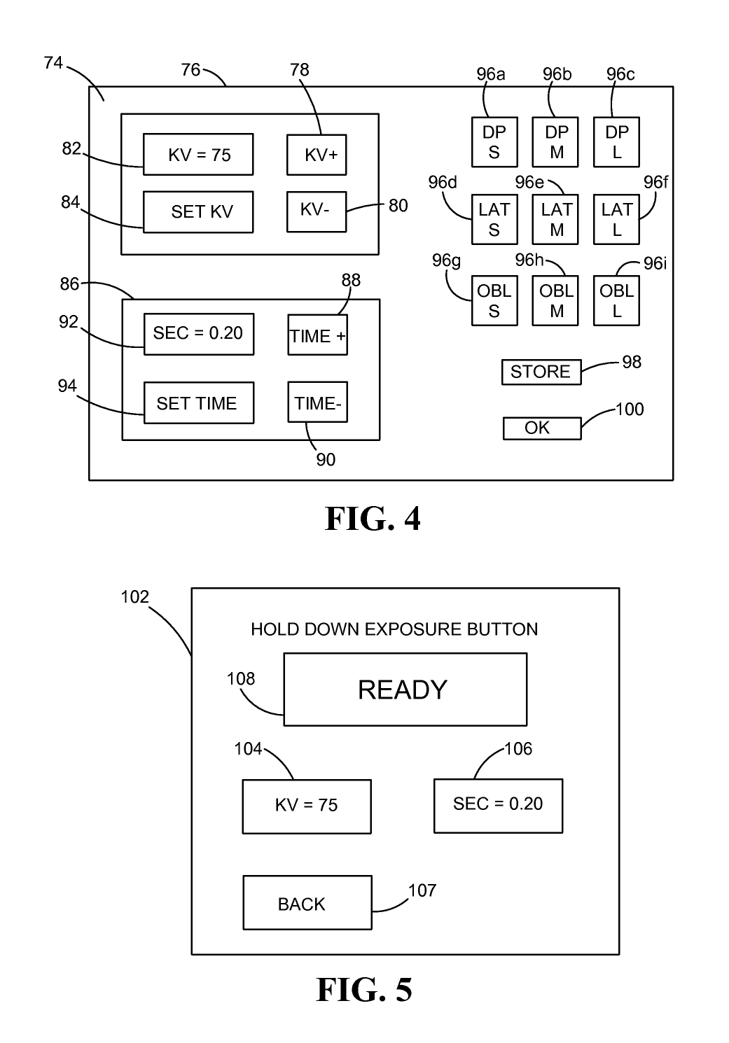

In response to an interaction detected in the area associated with the proceed button, the processor 66 may be programmed to advance to a control option screen 74 shown in FIG. 4. The exemplary control option screen 74 includes a voltage control area 76 having a voltage increase selectable item 78, a voltage decrease selectable item 80, and a voltage display box 82. An interaction detected at the voltage increase selectable item 78 may initiate an associated voltage increase function stored in the memory 68 that incrementally raises the voltage setting of the radiographic source 34, such as by 1 kV. Conversely, an interaction detected at the voltage decrease selectable item 80 may initiate an associated voltage decrease function stored in the memory 68 that incrementally lowers the voltage setting of the radiographic source 34. The processor 66 may further be programmed to display the current voltage setting value in the voltage display box 82. The voltage control area may include an optional voltage store selectable item 84 associated with a voltage store function that saves the current voltage setting value for a subsequent radiograph operation.

The control option screen 74 may also include an exposure time control area 86 having an exposure time increase selectable item 88, an exposure time decrease selectable item 90, and an exposure time display box 92. An interaction detected at the exposure time increase selectable item 88 may initiate an associated exposure time increase function stored in the memory 68 that incrementally raises the exposure time setting of the radiographic source 34, such as by 0.01 s. Conversely, an interaction detected at the exposure time decrease selectable item 90 may initiate an associated exposure time decrease function stored in the memory 68 that incrementally lowers the exposure time setting of the radiographic source 34. The processor 66 may further be programmed to display the current exposure time setting value in the exposure time display box 92. The exposure time control area may include an optional exposure time store selectable item 94 associated with an exposure time store function that saves the current exposure time setting value for a subsequent radiograph operation.

The control option screen 74 may further include a projection shortcut selectable item which permits a user to quickly and easily adjust the settings of the radiographic source 34 for a selected, predetermined projection and/or body type. Accordingly, the processor 66 may be programmed to execute a projection shortcut function when an interaction is detected at the projection shortcut selectable item. The processor 66 may be programmed to determine a set of predetermined voltage and exposure time signals when the location signal is associated with the projection shortcut selectable item.

In the embodiment illustrated in FIG. 4, the control option screen 74 includes a plurality of projection shortcut selectable items 96, with the processor 66 executing a projection shortcut function associated with each projection shortcut selectable item 96. For example, projection shortcut selectable items 96a-c may designate shortcuts for dorsal/plantar projections for small, medium, and large body types, respectively. When the location signal is associated with the projection shortcut selectable item 96a for a small body type, the processor 66 may be programmed to determine a first set of predetermined voltage and exposure time signals. Similarly, second and third sets of predetermined voltage and exposure time signals may be respectively associated with the projection shortcut selectable items 96b, 96c for medium and large body types. In an exemplary embodiment, the first set of predetermined signals may include a voltage signal of 50 kV and an exposure time of 0.5 s, the second set may include a voltage signal of 50 kV and an exposure time of 0.75 s, and the third set may include a voltage signal of 60 kV and an exposure time of 0.5 s.

The projection shortcut selectable items 96d-f may designate shortcuts for lateral projections for small, medium, and large body types, respectively. Again, the processor 66 may be programmed to determine fourth, fifth, and sixth sets of predetermined voltage and exposure time signals respectively associated with the selectable item 96d for lateral projection/small body type, selectable item 96e for lateral projection/medium body type, and selectable item 96f for lateral projection/large body type. In an exemplary embodiment, the fourth set of signals may include a voltage signal of 55 kV and an exposure time of 0.5 s, the fifth set may include a voltage signal of 65 kV and an exposure time of 0.75 s, and the sixth set may include a voltage signal of 65 kV and an exposure time of 0.5 s.

Still further, the projection shortcut selectable items 96g-i may designate shortcuts for oblique projections for small, medium and large body types, respectively. The processor 66 may be programmed to determine seventh, eighth, and ninth sets of predetermined voltage and exposure time signals respectively associated with the selectable item 96g for oblique projection/small body type, selectable item 96h for oblique projection/medium body type, and selectable item 96i for oblique projection/large body type. In an exemplary embodiment, the seventh set of signals may include a voltage signal of 60 kV and an exposure time of 0.5 s, the eighth set may include a voltage signal of 70 kV and an exposure time of 0.75 s, and the ninth set may include a voltage signal of 70 kV and an exposure time of 0.5 s.

While the exemplary embodiment includes nine projection shortcut selectable items 96a-i, it will be appreciated that fewer or greater than nine projection shortcut selectable items may be provided. Additionally, while the selectable items are illustrated as using text to indicate the function associated with the selectable item, icons may alternatively be used.

The control option screen 74 may also include a store selectable item 98 for saving all current parameter values. For example, the processor 66 may be programmed to store the current settings for voltage and exposure time, which may be displayed in the voltage display box 82 and the exposure time display box 92, respectively. The processor 66 may be programmed to use those settings the next time the control option screen 74 is used.

The control option screen 74 further includes a selectable item 100 for locking the settings prior to taking the radiographic image. In the illustrated embodiment, the selectable item 100 is marked with an “OK”. The processor 66 may be programmed to prevent further adjustment of the settings once the selectable item 100 is selected. In response, a confirmation screen 102 (FIG. 5) may be shown on the display 62. The confirmation screen may include a voltage display box 104 for showing the selected voltage setting, an exposure time display box 106 for showing the selected exposure time setting, and a back button 107 for returning to the control option screen 74. In addition, the confirmation screen 102 includes a ready status box 108, which indicates that the control values are set and the radiographic source 34 may be operated to generate the desired radiation dose.

In operation, the touch screen control may be configured to show a plurality of selectable items on the display, detect a location of an object interacting with the display and generate a location signal, identify one of the selectable items as an operative selectable item corresponding to the location signal, and execute a function associated with the operative selectable item by adjusting at least one of the voltage and exposure time of the radiographic source.

While only certain embodiments have been set forth, alternatives and modifications will be apparent from the above description to those skilled in the art. These and other alternatives are considered equivalents and within the spirit and scope of this disclosure and the appended claims.

What is claimed is:

1. A radiographic device comprising:
a base;
a support arm coupled to the base;
a radiographic source coupled to the support arm and operable to generate a radiographic dose having a voltage and an exposure time;
a touch screen including:
a display operable to show a control option screen, the control option screen including a plurality of selectable items; and
a location detector for detecting a location of an object interacting with the display and generating a location signal; and
a processor operably coupled to the radiographic source and the touch screen and including a memory, wherein the processor is configured to:
store a plurality of executable functions, wherein each executable function is associated with a selectable item;
identify one of the selectable items as an operative selectable item corresponding to the location signal; and
execute the function associated with the operative selectable item by adjusting at least one of the voltage and exposure time of the radiographic source.

2. The radiographic device of claim 1, in which the plurality of selectable items includes a voltage increase item, a voltage decrease item, an exposure time increase item, and an exposure time decrease item.

3. The radiographic device of claim 2, in which the plurality of executable functions includes a voltage increase function associated with the voltage increase item, a voltage decrease function associated with the voltage decrease item, an exposure time increase function associated with the exposure time increase item, and an exposure time decrease function associated with the exposure time decrease item.

4. The radiographic device of claim 1, in which:
the plurality of selectable items includes a first projection shortcut selectable item; and
the processor is programmed to store a first projection shortcut function associated with the first projection shortcut selectable item, the first projection shortcut function including a first projection voltage value and a first projection exposure time value.

5. The radiographic device of claim 4, in which the first projection shortcut selectable item comprises a first lateral projection item, and in which the first projection shortcut function includes a first lateral projection voltage value and a first lateral projection exposure time.

6. The radiographic device of claim 4, in which the first projection shortcut selectable item comprises a first oblique projection item, and in which the first projection shortcut function includes a first oblique projection voltage value and a first oblique projection exposure time.

7. The radiographic device of claim 4, in which the first projection shortcut selectable item comprises a first dorsal/plantar projection item, and in which the first projection shortcut function includes a first dorsal/plantar projection voltage value and a first dorsal/plantar projection exposure time.

8. The radiographic device of claim 4, further comprising a second projection shortcut selectable item, wherein the processor is programmed to store a second projection shortcut function associated with the second projection shortcut selectable item, the second projection shortcut function including a second projection voltage value different from the first projection voltage value and a second projection exposure time value different from the first projection exposure time value.

9. The radiographic device of claim 8, in which the first projection shortcut function is associated with a first podiatric projection angle, and in which the second projection shortcut function is associated with a second podiatric projection angle.

10. The radiographic device of claim 8, in which the first projection shortcut function is associated with a first body type, and in which the second projection shortcut function is associated with a second body type.

11. The radiographic device of claim 1, in which one of the selectable items comprises a store selectable item, and in which the processor is programmed to store a current value associated with the store selectable item.

12. A method of controlling a radiographic device having a base, a support arm coupled to the base, and a radiographic source coupled to the support arm and operable to generate a radiographic dose having a voltage and an exposure time, the method comprising:
showing a plurality of selectable items on a display;
detecting a location of an object interacting with the display and generating a location signal;
identifying one of the selectable items as an operative selectable item corresponding to the location signal; and
executing a function associated with the operative selectable item by adjusting at least one of the voltage and exposure time of the radiographic source.

13. A controller for a radiographic device, the radiographic device including a base, a support arm coupled to the base, and a radiographic source coupled to the support arm and operable to generate a radiographic dose having a voltage and an exposure time, the controller comprising:
a display operable to show a control option screen, the control option screen including:
a voltage control area including a voltage increase selectable item, a voltage decrease selectable item, and a voltage display box configured to display a voltage setting value;
an exposure time control area including an exposure time increase selectable item, an exposure time decrease selectable item, and an exposure time display box configured to display an exposure time setting value; and
a first projection shortcut selectable item;
a location detector for detecting a location of an object interacting with the display and generating a location signal; and
a processor operably coupled to the touch screen and having a memory, wherein the processor is configured to:
determine a voltage increase signal when the location signal is associated with the voltage increase selectable item;
determine a voltage decrease signal when the location signal is associated with the voltage decrease selectable item;
determine an exposure time increase signal when the location signal is associated with the exposure time increase selectable item;
determine an exposure time decrease signal when the location signal is associated with the exposure time decrease selectable item; and
retrieve a first set of predetermined voltage and exposure time values stored in the memory and determine a first set of predetermined voltage and exposure time signals associated with the first set of predetermined voltage and exposure time values when the location signal is associated with the first projection shortcut selectable item.

14. The controller of claim 13, in which:
the control option screen further includes a second projection shortcut selectable item; and
the processor is further configured to retrieve a second set of predetermined voltage and exposure time values stored in the memory and determine a second set of predetermined voltage and exposure time signals associated with the second set of predetermined voltage and exposure time values when the location signal is associated with the second projection shortcut selectable item.

15. The controller claim 14, in which the first set of predetermined voltage and exposure time values is associated with a first podiatric projection angle, and in which the second set of predetermined voltage and exposure time values is associated with a second podiatric projection angle.

16. The controller of claim 14, in which the first set of predetermined voltage and exposure time values is associated with a first body type, and in which the second set of predetermined voltage and exposure time values is associated with a second body type.

17. The controller of claim 14, in which:
the control option screen further includes a store selectable item; and
the processor is further configured to store in the memory at least one of a current voltage value and a current exposure time value when the location signal is associated with the store selectable item.
